(19) United States
(12) Patent Application Publication
(10) Pub. No.: US 2023/0306439 A1
(43) Pub. Date: Sep. 28, 2023

(54) SYSTEM, METHOD, AND APPARATUS REGISTERING DOCUMENTATION OF TRAINING ON A DISTRIBUTED LEDGER

(71) Applicants: Keel Coleman, Roanoke, VA (US); Lennox McNeary, Roanoke, VA (US)

(72) Inventors: Keel Coleman, Roanoke, VA (US); Lennox McNeary, Roanoke, VA (US)

(21) Appl. No.: 17/656,085

(22) Filed: Mar. 23, 2022

(51) Int. Cl. G06Q 30/00

(52) U.S. Cl. CPC G06Q 30/018

(57) ABSTRACT

A system, apparatus, and method to for registering documentation of training from a primary source onto a distributed ledger with time-limited data warehousing in a secure container is disclosed. The system maintains data at the source of origin, while providing access to documents and the provenance of their generation. The system increases portability of the documentation without degrading or creating a surrogate source.

### BACKGROUND OF THE INVENTION

The present invention relates to credentialing, and more particularly to credentialing for professional licensure and training certification.

Healthcare Systems, educational training sites, other corporate, and professional entities are required to meet credentialing standards for professionals dictated by accreditation bodies, payers and patient advocacy groups. The verification of the primary source documentation of training and performance is a critical step in assuring that professionals can competently and safely deliver service to their patrons. The current system is time consumptive. Other companies using distributed ledgers are creating exchanges on which data may be obtained. Personal data in the professional space is not a commodity. The process by which information may be obtained is a product.

Professional credentialing is a trustless, interrogative process. Currently, other distributed ledger platforms, self-delegate the role of the trusted data provider to their ledgers or servers. This side-steps the intent and purpose of primary source verification.

The current systems are time consuming. Historically, the process by which professional credentials are verified involves phone calls, faxes, and emails. These multiple forms of contact increase the constraints on time that create barriers to care, and impact professional employment.

There is a need for improved systems, apparatus, and methods to maintain credentialing data at the source of origin, provide access to documents and the provenance of their generation.

### SUMMARY OF THE INVENTION

In one aspect of the present invention, an apparatus for programmatically providing a network-based credential verification service is disclosed. The apparatus includes a server executing computer program code to host the network-based credential verification service. The server has at least one processor and at least one memory. Computer program code executing on the server provides instructions via a communications network, to: receive a digital training document uniquely associated with a candidate by a named person identifier (random identity generation or NPI); for the digital training document, a hash for the digital training document; store the hash for the digital training document as a result on a distributed ledger in communication with the server; and collate a location of the resultant hash on the distributed ledger with the digital training document retained by the generating entity.

In some embodiments, the computer program code executing on the server providing instructions to receive, via the communications network, a request for the digital training document of the candidate; transmit the request to the generating entity; and store the digital training document in a secure container in communication with the server.

In some embodiments, computer program code executing on the server provides instructions via the communications network, to retrieve the digital training document from the secure container, generate a hash of the retrieved digital training document; retrieve the resultant hash from the distributed ledger; and compare the hash with the resultant hash to verify an authenticity of the digital training document.

In some embodiments, computer program code executing on the server provides instructions via the communications network, to record a verification time and a verification date, when the hash matches the resultant hash.

In some embodiments, the digital training document has a title including a document name, a name of the candidate, and the personal identifier.

In other aspects of the invention, a system for providing a network-based credential verification service is disclosed. The system includes a server hosting the network-based credential verification service. The server is configured to serve one or more web pages for interacting with the network-based credential verification service via a communications network. A distributed ledger, in communication with the server, contains a resultant hash of a digital training document supporting the credentials of a candidate. The digital training document has a named person identifier (NPI or other generated identifier) associating the digital training document with a candidate. A time-locked secured canister is configured to receive a digital training document from a generating source of the training document. The digital training document is collated with a location of the resultant hash of the digital training document in the distributed ledger.

In some embodiments, the system includes a comparator configured to compare a hash of the digital training document in the time-locked secure canister with the resultant hash retrieved from the distributed ledger. When the hash and the resultant hash correspond, a provenance of the digital training document is verified.

In some embodiment, the system includes a dashboard presenting a time, a date, the provenance, and a location of the digital training document.

In yet other aspects of the invention, a computer program product configured to programmatically provide a network-based credential verification service is disclosed. The computer program product includes at least one non-transitory computer-readable storage medium having computer-executable program code instructions stored therein. The computer-executable program code instructions include program code instructions for providing from a server hosting the network-based credential verification service, via a communications network, instructions to: receive a digital training document uniquely associated with a candidate by a named person identifier (NPI or other generated identifier); generate, by a generating entity for the digital training document, a hash for the digital training document; store the hash for the digital training document as a resultant hash on a distributed ledger in communication with the server; and collate a location of the resultant hash on the distributed ledger with the digital training document retained by the generating entity.

In some embodiments, the computer program code executing on the server provide instructions via the communications network, to receive, via the communications network, a request for the digital training document of the candidate; transmit the request to the generating entity; and store the digital training document in a secure container in communication with the server.

In some embodiments, the computer program code executing on the server provides instructions via the communications network, to retrieve the digital training document from the secure container; generate a hash of the retrieved digital training document; retrieve the resultant hash from the distributed ledger; and compare the hash with the resultant hash to verify a provenance of the digital training document.

In some embodiments, the computer program code executing on the server provide instructions via the communications network, to record a verification time and a verification date, when the hash matches the resultant hash.

In some embodiments, the digital training document has a title including a document name, a name of the candidate, and the NPI.

These and other features, aspects and advantages of the present invention will become better understood with reference to the following drawings, description and claims.

### BRIEF DESCRIPTION OF THE DRAWINGS

FIG. 1 is a flow chart of the invention, showing the document management process.

FIG. 2 is a flow chart of the invention, showing the verification and confirmation process.

FIG. 3 is a flow chart of the invention, showing a document transfer process.

FIG. 4 is a flow chart of the invention, showing the register process.

FIG. 5 is a flow chart of the invention, showing the verification process.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide a system, method, apparatus, and computer program product that provides access to verification of credentialing data, training documentation via a distributed ledger. The system maintains credentialing data at the source of origin, while providing access to training documentation and the provenance of their generation. The present invention increases portability of training documentation without degrading or creating a surrogate source. The credentials, in the form of training documentation is retained as an electronic record.

Professional credentialing is a trustless, interrogative process. Currently, other distributed ledger platforms, self-delegate the role of a trusted data provider to their ledgers or servers. This structure side-steps the intent and purpose of primary source verification. The invention claimed here solves this problem.

The present invention maintains credentialing data, collectively training documentation, at the source of origin. The present invention is applicable to fixed qualifications, such as attainment of a degree, as well as recurring qualification requirements, such as continuing education and recertification requirements that may expire after a specified temporal period. The invention is an improvement over the current credentialing paradigm by improving primary source verification from a 1 to 15-hour process to one that takes seconds.

The system creates an immutable verification mechanism by which credentials, reflecting one or more training documents, can be perpetually stored. The data management component of the system creates consistency across platforms for increased management efficiency.

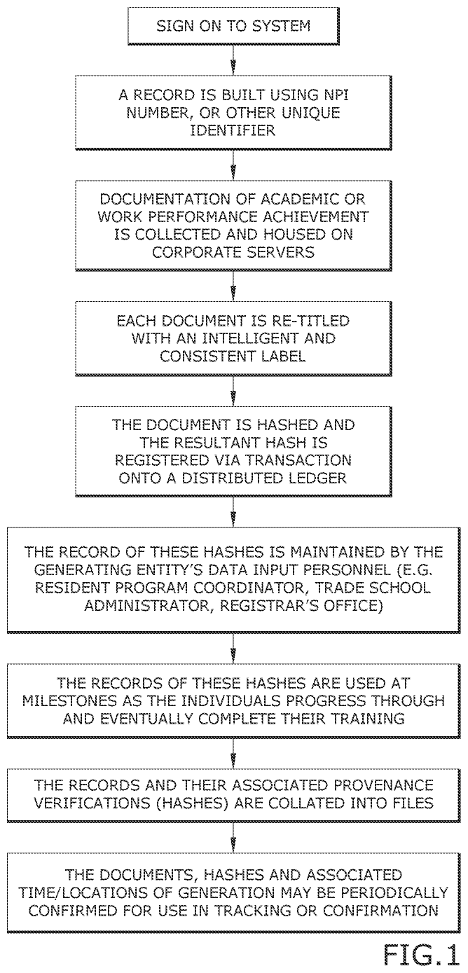

A training documentation management process is illustrated in reference to FIG. 1. At a first step, a user logs onto the system. Once logged in, an applicant record is constructed using a Named Person Identifier (NPI), or another unique identifier. Training documentation of an academic or a work performance achievement for an applicant is collected and housed on a corporate server with the training documentation linked to the applicant using the NPI.

Each training document is then re-titled with an intelligent and consistent label. By way of non-limiting example, each selected training document is renamed with a title including its document name, the name of the applicant/trainee/student, and the NPI. The renamed training document is then hashed, and the resultant hash is registered via a transaction onto a distributed ledger.

A record of the resultant hash is maintained by data input personnel of a generating entity. The generating entity may include a resident program coordinator, a trade school administrator, a registrar's office of a college or university, or other training center documentation personnel.

The records of the resultant hashes are used at one or more milestones as the individual progresses through and eventually completes their training leading to a degree, a certification, or the like. The records and their associated provenance verifications (the resultant hashes) are collated into files. After collation, the documents, resultant hashes, and an associated time and location of generation may be periodically confirmed for use in a tracking or a confirmation process.

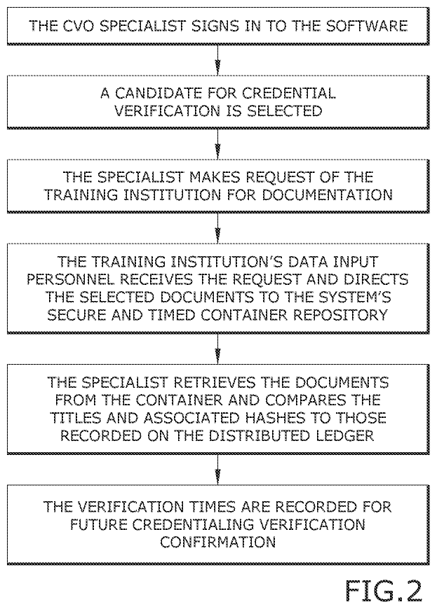

A verification and confirmation process is shown in reference to FIG. 2. In this instance a candidate verification office (CVO) specialist logs into the system. A candidate for credential verification is selected. The CVO specialist makes a request of the training institution for the candidates training documentation.

The training institution's data input personnel receive the request and directs the selected training documents for the candidate to a secure and timed container repository. As will be appreciated, this process may be automated. The secure and timed container repository may be accessible via a web-based portal hosted by a server of the credentialing service provider. The CVO specialist retrieves the training documents from the secure and timed container repository.

The system compares the titles and associated hashes for the training documents with the titles and resultant hashes recorded on the distributed ledger. When the titles and associated hashes match with the titles and resultant hashes recorded on the distributed ledger, a verification time and date may be recorded with the candidates record for reference during a future credentialing verification confirmation.

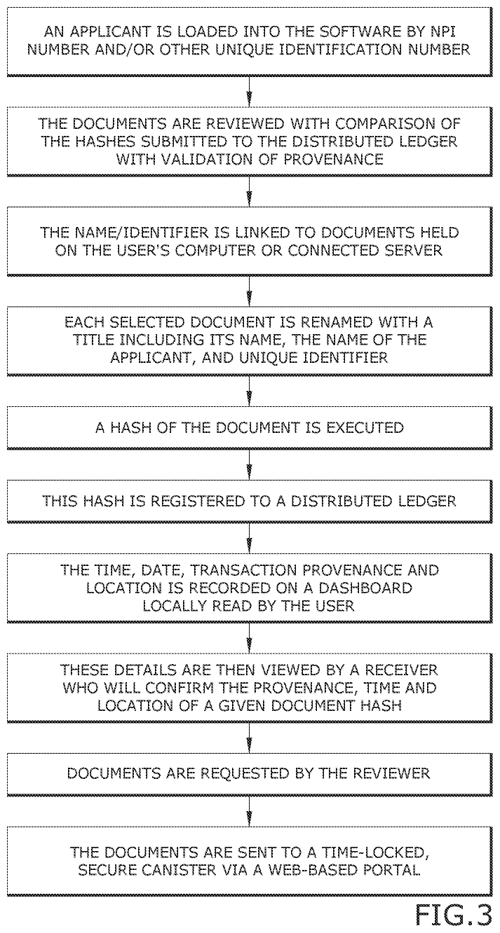

In another implementation shown in reference to FIG. 3, an applicant is loaded into the system by NPI number or other unique identification number. Training documents are reviewed with a comparison of the hashes submitted to the distributed ledger with a validation of the training document's provenance. The NPI is linked to documents held on the user's computer or a connected server. Each selected training document is renamed with a title including its name, the name of the applicant, and the NPI. A hash of the training document is then executed, and the hash is registered to the distributed ledger.

A time, a date, a transaction provenance, and a location of the training document is recorded on a dashboard locally read by the user. A recipient of the training documents may view each of the time, the date, the transaction provenance, and the location of a given document hash, such as by a web browser.

In this process a reviewer may request the training documents. The training documents may be sent to a time-locked, secure canister, accessible via a web-based portal.

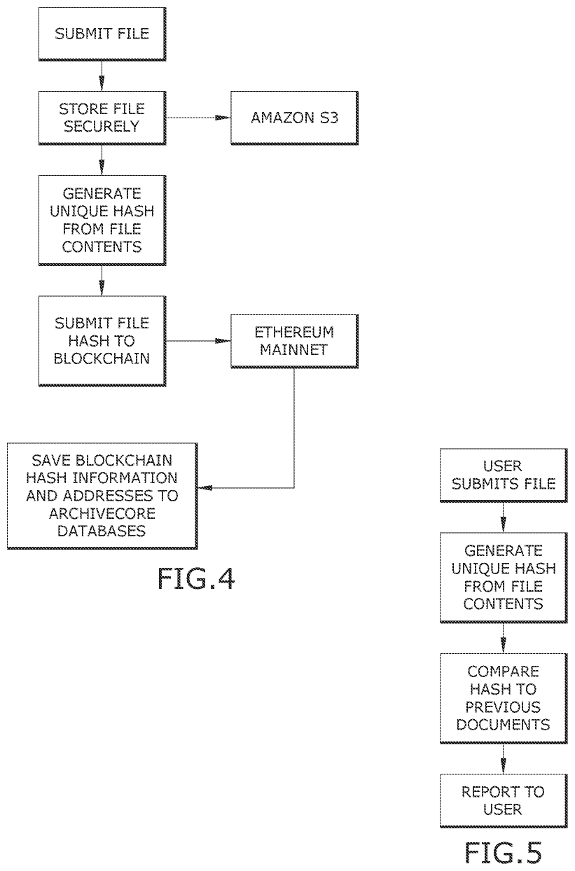

A summarized process of implementing the invention is shown in reference to FIG. 4. In this instance a user submits a training document. The training document is securely stored, for example on a cloud-based server, such as Amazon S3. A unique hash of the training document is generated from the training document. The resultant hash for the training document is submitted to a blockchain. The resultant hash may be stored, for example, on an Ethereum Main net. The location of the resultant hash for the training document on the blockchain may be stored to one or more archive core databases to provide a reference for verifying the authenticity and provenance of the training document. As such, the system provides for maintaining training documentation data at the source of origin and provide access to verification of the provenance of their generation. The process increases portability without degrading or creating a surrogate source as the training document, once delivered, can be verified against the resultant hash for the training document retained on the distributed ledger. The time, date, transaction provenance and location are accessible via a web-based dashboard and locally read by the user.

A summarized process for verifying a training document may be seen in reference to FIG. 5. In this instance, a recipient of a training document submits a copy of the training document file to the server. The server generates a hash of the submitted training document. The hash is compared with the resultant hash associated with the training document on the distributed ledger. Once the hash is verified with the resultant hash, a report of authenticity of the training documents provenance and authenticity is then provided.

The server-based platform may be accessed by one or more subscribers. For a training institution subscriber, the training documents they hold are hashed and registered to the distributed ledger. The hash of the document, the transaction and the registration file may then be viewed by verification service subscribers. The system is strengthened with the incorporation of one or more application program interfaces (API) between training, credentialing, or other personnel management software. As will be appreciated, this system could be deployed to any service/trade or profession requiring primary source verification of credentialing documentation. Examples include contracting, law, vocational trades, and finance.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like,

The ordered combination of various ad hoc and automated tasks in the presently disclosed platform necessarily achieve technological improvements through the specific processes described more in detail below. In addition, the unconventional and unique aspects of these specific automation processes represent a sharp contrast to merely providing a well-known or routine environment for performing a manual or mental task.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. An apparatus for programmatically providing a network-based credential verification service, the apparatus comprising:
a server executing computer program code to host the network-based credential verification service, the server having at least one processor and at least one memory;
computer program code executing on the server providing instructions via a communications network, to:
receive a digital training document uniquely associated with a candidate by a named person identifier (NPI);
generate, by a generating entity for the digital training document, a hash for the digital training document;
store the hash for the digital training document as a resultant hash on a distributed ledger in communication with the server; and
collate a location of the resultant hash on the distributed ledger with the digital training document retained by the generating entity.

2. The apparatus of claim 1, further comprising:
computer program code executing on the server providing instructions via the communications network, to
receive, via the communications network, a request for the digital training document of the candidate;
transmit the request to the generating entity; and
storing the digital training document in a secure container in communication with the server.

3. The apparatus of claim 2, further comprising:
computer program code executing on the server providing instructions via the communications network, to
retrieve the digital training document from the secure container;
generate a hash of the retrieved digital training document;
retrieve the resultant hash from the distributed ledger; and
compare the hash with the resultant hash to verify an authenticity of the digital training document.

4. The apparatus of claim 3, further comprising:
computer program code executing on the server providing instructions via the communications network, to
record a verification time and a verification date when the hash matches the resultant hash.

5. The apparatus of claim 1, wherein the digital training document has a title including a document name, a name of the candidate, and the NPI.

6. A system for providing a network-based credential verification service, comprising:
a server hosting the network-based credential verification service, configured to serve one or more web pages for interacting with the network-based credential verification service via a communications network;
a distributed ledger, in communication with the server, the distributed ledger containing a resultant hash of a digital training document supporting a credential of a candidate, the digital training document having a named person identifier (NPI) associating the digital training document with a candidate; and
a time-locked secured canister configured to receive a digital training document from a generating source of the training document, the digital training document collated with a location of the resultant hash of the digital training document in the distributed ledger.

7. The system of claim 6, further comprising:
a comparator configured to compare a hash of the digital training document in the time-locked secure canister with the resultant hash retrieved from the distributed ledger, wherein when the hash and the resultant hash correspond, a provenance of the digital training document is verified.

8. The system of claim 7, further comprising:
a dashboard presenting a time, a date, the provenance, and a location of the digital training document.

9. A computer program product configured for to programmatically providing a network-based credential verification service, the computer program product comprising at least one non-transitory computer-readable storage medium having computer-executable program code instructions stored therein, the computer-executable program code instructions comprising program code instructions for providing from a server hosting the network-based credential verification service, via a communications network, instructions to:
receive a digital training document uniquely associated with a candidate by a named person identifier (NPI);
generate, by a generating entity for the digital training document, a hash for the digital training document;
store the hash for the digital training document as a resultant hash on a distributed ledger in communication with the server; and
collate a location of the resultant hash on the distributed ledger with the digital training document retained by the generating entity.

10. The computer program product of claim 9, further comprising:
computer program code executing on the server providing instructions via the communications network, to
receive, via the communications network, a request for the digital training document of the candidate;
transmit the request to the generating entity; and
store the digital training document in a secure container in communication with the server.

11. The computer program product of claim 10, further comprising:
computer program code executing on the server providing instructions via the communications network, to
retrieve the digital training document from the secure container; and
generate a hash of the retrieved digital training document;
retrieve the resultant hash from the distributed ledger; and
compare the hash with the resultant hash to verify a provenance of the digital training document.

12. The computer program product of claim 11, further comprising:
computer program code executing on the server providing instructions via the communications network, to
record a verification time and a verification date when the hash matches the resultant hash.

13. The computer program product of claim 9 wherein the digital training document has a title including a document name, a name of the candidate, and the NPI.
